(19) United States
(12) Patent Application Publication
(10) Pub. No.: US 2012/0248853 A1
(43) Pub. Date: Oct. 4, 2012

(54) Apparatus for the Protection of a Wheel When Applying a Tire Dressing

(76) Inventor: Venerando Casto, Orangeville (CA)

(21) Appl. No.: 13/076,681

(22) Filed: Mar. 31, 2011

(51) Int. Cl. B60B 7/01

(52) U.S. Cl. 301/37.103

(57) ABSTRACT

An apparatus for the protection of a wheel of a vehicle when applying a dressing to a tire mounted on the wheel. The apparatus comprises a shield and a gripping portion. The shield is sized and configured to cover the wheel and to permit access to the tire when the shield is placed against a side surface of the wheel. The gripping portion permits the shield to be held against the wheel through the use of one hand of an operator while leaving the operator's second hand free to apply the tire dressing.

### BACKGROUND OF THE INVENTION

1. Field of the Invention

This invention relates generally to an apparatus that may be used to protect the wheel of a vehicle when a dressing is applied to a tire mounted on the wheel.

2. Prior Art

When cleaning or detailing a vehicle, whether the vehicle is a car, truck, motorcycle or other type of tired vehicle, it is common for a dressing to be applied to the vehicle's tires. Such dressings are often used to clean the tires and/or apply a protective film that is intended to enhance the tire's appearance or extend its useful life. Typically, such dressings are in a liquid form and are applied to the vehicle's tires through the use of a spray applicator. Spraying the tires with a desired dressing is a relatively common and efficient manner of applying the dressing, however, in many instances it can result in overspray of the dressing coming into contact with the vehicle's wheels.

Often, overspray of tire dressing on a wheel is undesirable as it can lead to streaking and discoloration (for example, in the case of a car having chrome or highly polished aluminum wheels). The overspray can result in the necessity for further cleaning and detailing of the wheel.

There is therefore a need for a device or an apparatus that addresses such issues and provides a means to eliminate or minimize the likelihood of tire dressing coming into contact with the vehicle's wheels when the dressing is being applied to a tire mounted thereon.

### SUMMARY OF THE INVENTION

In one of its aspects the invention therefore provides an apparatus for the protection of a wheel of a vehicle when applying a dressing to a tire mounted on the wheel, the apparatus comprising a shield and a gripping portion, said shield sized and configured to cover the wheel and to permit access to the tire when said shield is placed against a side surface of the wheel, said gripping portion permitting said shield to be held against the wheel through the use of one hand of an operator while leaving the operator's second hand free to apply the tire dressing.

In a further aspect the invention provides an apparatus for the protection of a wheel of a vehicle when applying a dressing to a tire mounted on the wheel, the apparatus comprising a circular shield sized to cover the wheel and to permit access to the tire when said shield is placed against the wheel's side surface, said shield constructed from a fluid resistant material and comprised of two or more portions hingedly secured together, said shield having an open and a closed or folded position; and, a gripping portion, said gripping portion assisting in the holding of said shield against the wheel.

The invention also provides an apparatus for the protection of a wheel of a vehicle when applying a dressing to a tire mounted on the wheel, the apparatus comprising a circular shield sized to cover the wheel and to permit access to the tire when said shield is placed against the wheel's side surface, said shield comprised of a fluid resistant material having two or more portions hingedly secured together, said shield having an open and a closed or folded position; one or more fasteners to releasably maintain said shield in said closed or folded position; and, a plurality of finger holes extending through said shield, said finger holes permitting said shield to be held against the wheel through the use of one hand of an operator, leaving the operator's second hand free to apply the tire dressing.

Further aspects and advantages of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a side perspective view of a vehicle wheel and an apparatus constructed in accordance with one of the embodiments of the present invention;

FIG. 2 is a side elevational view of the vehicle wheel of FIG. 1 with the apparatus held against the wheel ready for the application of a tire dressing;

FIG. 3 is a front view of the apparatus of FIG. 1;

FIG. 4 is a rear view of the apparatus of FIG. 1;

FIG. 5 is a front view of the apparatus of FIG. 1 shown in its folded configuration;

FIG. 6 is a sectional view taken along the line 6-6 of FIG. 3;

FIG. 7 is a side view of an alternate embodiment of the apparatus; and,

FIG. 8 is a front view of the apparatus of FIG. 7.

### DETAILED DESCRIPTION OF THE PREFERRED EMBODIMENT

The present invention may be embodied in a number of different forms. However, the specification and drawings that follow describe and disclose only some of the specific forms of the invention and are not intended to limit the scope of the invention as defined in the claims that follow herein.

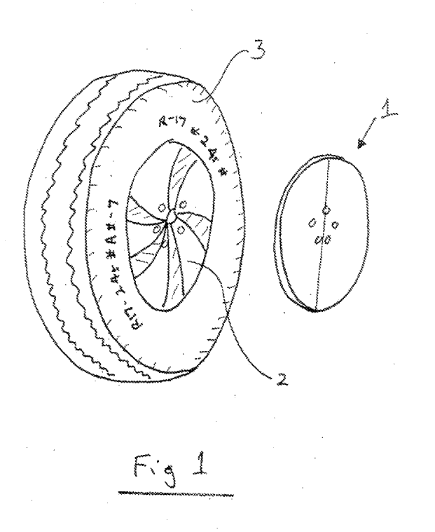

With reference to FIG. 1, there is shown an exemplary embodiment of an apparatus 1 according to the present invention prior to it being placed against the side surface of a wheel 2 having a tire 3 mounted thereon. Wheel 2 and tire 3 could be that of a passenger truck or car, motorcycle, delivery truck, or any one of a wide variety of other tired vehicles. In most instances, however, it is expected that the apparatus will be used in association with the wheel of a passenger vehicle, where the wheel is decorative in nature, to the extent that it is desirable to avoid tire dressing coming into contact with the wheel. It will be appreciated by those of ordinary skill in the art that tire dressings within the context of the present invention can be any one of a wide variety of different compounds or products that are, in general, used to clean or enhance the visual appearance of a tire. Tire dressings may in some instances include ultraviolet inhibitors to help prevent the degradation of the rubber compounds forming the tire.

Many tire dressings are in the form of sprays or foams that are dispensed from aerosol cans. Applying dressings to tires will in many cases inevitably result in at least some of the dressing coming into contact with the wheel through overspray and/or dripping. To help protect the wheel from being exposed to a tire dressing when the dressing is being applied to the tire, apparatus 1 generally comprises a shield 4 that is sized and configured to cover the wheel when placed against it. It is expected that in most instances shield 4 will therefore be generally circular and have a diameter approximating that of the wheel so that when the shield is pushed up against the side of the wheel the shield will cover the wheel while still permitting access to the tire. A dressing can then be applied to the tire while the shield helps to limit or minimize the dressing coming into contact with the wheel.

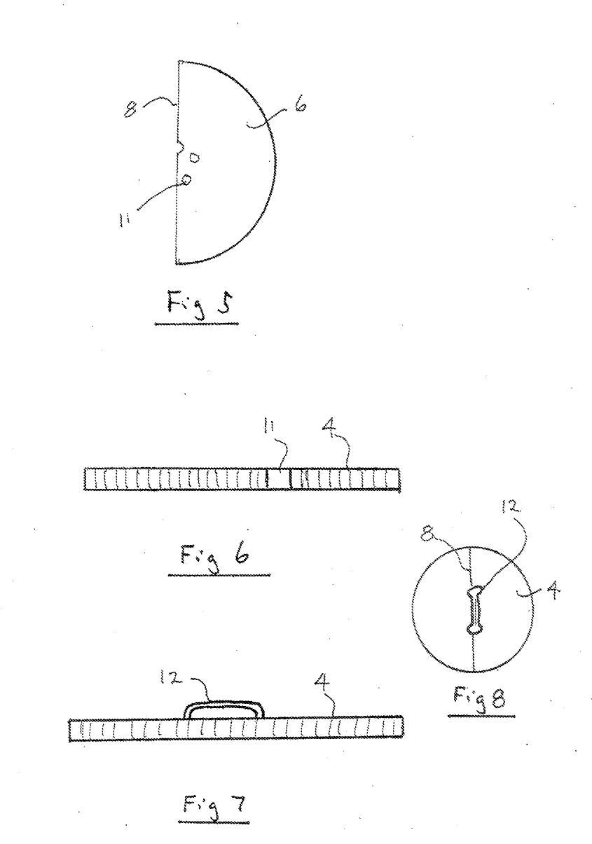

To assist in positioning shield 4 against the side of wheel 2, apparatus 1 includes a gripping portion 5. Gripping portion 5 allows an operator to hold shield 4 against wheel 2 with the use of one hand only, thereby leaving the operator's second hand free to apply the tire dressing. Once the dressing has been applied and the likelihood of overspray or dripping onto the wheel has been eliminated or reduced, the shield can be retracted from the wheel and the operator can move on to applying the dressing to other wheels of the vehicle. To permit apparatus 1 to be re-used time and time again, in one embodiment of the invention shield 4 is constructed from a fluid resistant material so that the tire dressing does not penetrate into the shield and can be easily wiped or washed off. In a further embodiment of the invention, the shield is constructed from a corrugated plastic material (for example, see FIGS. 6 and 7) creating a relatively strong and light weight shield.

For purposes of shipping and storing apparatus 1, in one of the exemplary embodiments of the invention shield 4 is comprised of two or more portions that are hingedly secured together. In the embodiment shown in the attached drawings, shield 4 is indicated as being formed from two portions, 6 and 7, that are secured together by hinge 8. Where shield 4 is constructed from a resilient material, such as a plastic or rubber, it is expected that hinge 8 will simply be an area of reduced thickness that forms a living hinge. In other instances a more traditional hinge could be utilized. It will thus be appreciated that apparatus 1 provides a shield having an open and a folded (closed) position. In order to help maintain shield 4 in its folded position, apparatus 1 may include one or more fasteners. In the embodiment shown in the attached drawings, the fasteners comprise co-operating hook and loop fasteners 9 and 10 that interact when first portion 6 is folded along hinge 8, covering second portion 7. In this manner, shield 4 will be releasably maintained in its folded.

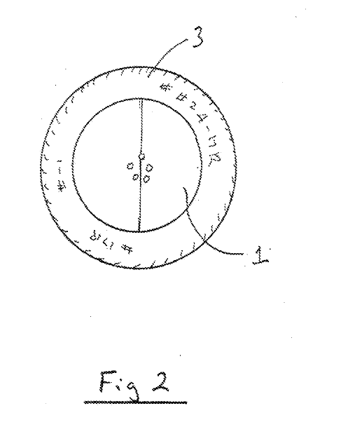

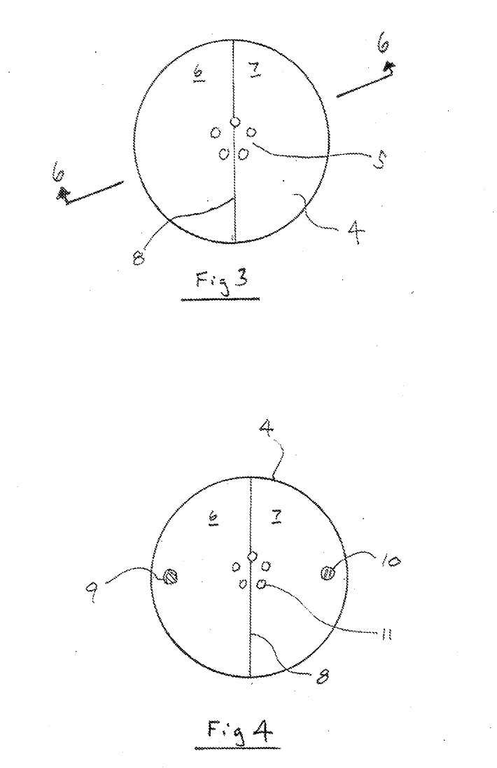

It will also be appreciated by those skilled in the art that gripping portion 5 of apparatus 1 may take a variety of different forms. In the embodiment shown in FIGS. 1 through 6, gripping portion 5 is comprised of a plurality of finger holes 11 that extend through shield 4. The finger holes are sized such that they allow an operator to insert his or her fingers and/or thumb through one or more holes in order to grasp shield 4 and hold it against the side of wheel 2. In the embodiment depicted, there are five finger holes. It will, however, be appreciated that one or more finger holes could be utilized while the remaining within the broad scope of the invention. In the alternate embodiment of the invention shown in FIGS. 7 and 8, gripping portion 5 comprises a handle 12. Handle 12 may be a separate element that is mechanically fastened or chemically bonded to the outer surface of shield 4. Alternatively, handle 12 could be an opening cut into the surface of the shield or a cut-out in the shield that is folded outwardly to allow it to be grasped by an operator. In a further embodiment, handle 12 could be in the form of a knob.

It will be appreciated from a thorough understanding of the invention that apparatus 1 provides a mechanism that can be placed against the side of a wheel to allow for the application of a tire dressing to a tire mounted on the wheel without exposing the wheel to the dressing material. The apparatus and its structure permits an operator to quickly move from wheel to wheel without having to adjust the apparatus or be concerned with removing dressing that may have come into contact with the wheel. The operator merely places shield 4 against the wheel, applies the tire dressing to the tire, retracts the shield from the wheel, moves to the next wheel on the vehicle and repeats the process. When the tire dressing has been applied to all of the wheels of a vehicle, any overspray or dressing that may have come into contact with shield 4 can be wiped or cleaned off, after which the shield can be folded and stored for future use. Shields of different diameters can be made to accommodate different sizes of wheels.

It is to be understood that what has been described are some of the exemplary embodiments of the invention and that it may be possible to make variations to these embodiments while staying within the broad scope of the invention. Some of these variations have been discussed while others will be readily apparent to those skilled in the art.

What is claimed is:

1. An apparatus for the protection of a wheel of a vehicle when applying a dressing to a tire mounted on the wheel, the apparatus comprising:
a shield and a gripping portion, said shield sized and configured to cover the wheel and to permit access to the tire when said shield is placed against a side surface of the wheel, said gripping portion permitting said shield to be held against the wheel through the use of one hand of an operator while leaving the operator's second hand free to apply the tire dressing.

2. The apparatus as claimed in claim 1 wherein said shield is constructed from a fluid resistant material.

3. The apparatus as claimed in claim 1 wherein said shield is constructed from a corrugated plastic material.

4. The apparatus as claimed in claim 1 wherein said shield is comprised of two or more portions hingedly secured together, said shield having an open and a closed or folded position.

5. The apparatus as claimed in claim 4 wherein said shield includes one or more fasteners to releasably maintain said shield in said closed or folded position.

6. The apparatus as claimed in claim 1 wherein said gripping portion comprises at least one finger hole extending through said shield.

7. The apparatus as claimed in claim 1 wherein said gripping portion is a handle or knob.

8. An apparatus for the protection of a wheel of a vehicle when applying a dressing to a tire mounted on the wheel, the apparatus comprising:
(i) a circular shield sized to cover the wheel and to permit access to the tire when said shield is placed against the wheel's side surface, said shield constructed from a fluid resistant material and comprised of two or more portions hingedly secured together, said shield having an open and a closed or folded position; and,
(ii) a gripping portion, said gripping portion assisting in the holding of said shield against the wheel.

9. The apparatus as claimed in claim 8 wherein said shield includes one or more fasteners to releasably maintain said shield in said folded position.

10. An apparatus for the protection of a wheel of a vehicle when applying a dressing to a tire mounted on the wheel, the apparatus comprising:
(i) a circular shield sized to cover the wheel and to permit access to the tire when said shield is placed against the wheel's side surface, said shield comprised of a fluid resistant material having two or more portions hingedly secured together, said shield having an open and a closed or folded position;
(ii) one or more fasteners to releasably maintain said shield in said closed or folded position; and,
(iii) a plurality of finger holes extending through said shield, said finger holes permitting said shield to be held against the wheel through the use of one hand of an operator, leaving the operator's second hand free to apply the tire dressing.
